(19) United States
(12) Patent Application Publication
(10) Pub. No.: US 2022/0282148 A1
(43) Pub. Date: Sep. 8, 2022

(54) PARAFFIN INHIBITOR FORMULATIONS FOR OIL AND GAS APPLICATIONS

(71) Applicant: Pilot Polymer Technologies, Inc., Pittsburgh, PA (US)

(72) Inventors: Robin Singh, Oakmont, PA (US); Joseph Michael Miller, Charleroi, PA (US); James William Ogle, Pittsburgh, PA (US)

(21) Appl. No.: 17/687,845

(22) Filed: Mar. 7, 2022

Related U.S. Application Data
(60) Provisional application No. 63/200,450, filed on Mar. 8, 2021.

(51) Int. Cl. C09K 8/524

(52) U.S. Cl. CPC C09K 8/524

(57) ABSTRACT

The present disclosure generally relates to paraffin inhibitor formulations useful to inhibit formation of paraffin aggregates and paraffin deposition on the metal surfaces during hydrocarbon production, transportation, and refining process. The paraffin inhibitor formulations can lower the pour point of the crude oil, improve the flow characteristics of the oil, inhibit paraffin deposition on metal surfaces and disperse paraffin aggregates in the oil. Methods of making and using the paraffin inhibitor formulations are further disclosed.

### CROSS-REFERENCE TO RELATED APPLICATIONS

The present application claims the priority benefit of U.S. Provisional Patent App. Ser. No. 63/200,450, entitled PARAFFIN INHIBITOR FORMULATIONS FOR OIL AND GAS APPLICATIONS, filed Mar. 8, 2021, which is hereby incorporated herein by reference in its entirety.

### TECHNICAL FIELD

The present disclosure relates to paraffin inhibitor formulations used to inhibit formation of paraffin aggregates and paraffin deposition on the metal surfaces during hydrocarbon production, transportation, and refining processes.

### BACKGROUND

Crude oils are complex multicomponent mixtures of different chemical compounds including alkanes, aromatics, cycloalkanes, resins and asphaltenes. The mixtures can contain dissolved paraffin/waxes which are typically miscible with the crude oil under reservoir conditions of high pressure and temperature. The dissolved paraffins are primarily C18 to C80+ carbon chain alkanes. Such paraffins can precipitate and deposit out of the crude oil under certain conditions. For example, the paraffins can precipitate in wellbore tubing during production when the temperature and pressure becomes lower as the oil reaches the surface or within the reservoir matrix if the reservoir pressure is depleted. Typically, deposition occurs when the temperature drops below the Wax Appearance Temperature (“WAT”) which can cause crystallization of the paraffin. Nucleation, growth, and aggregation can also increase the size of the paraffin deposit. The crystal morphologies can be orthorhombic, hexagonal, monoclinic, and triclinic. These crystal aggregates can bind to the metal surfaces owing to the temperature gradient between the crude oil and metal surface.

Paraffin deposition during hydrocarbon production, transportation, and refining processes are one of the major flow assurance issues faced by oil and gas industry. In upstream applications, paraffin deposition can lead to plugging of wellbore tubing, surface production equipment, and pumps and can result in complete well shutdown and pose a major operational and safety challenge. Paraffin blockage remediation is a costly process for operators. There are several paraffin prevention and remediation techniques adopted by the oil and gas industry. These include mechanical intervention, thermochemical reactions, cold flow technology, special pipe coatings, solvent treatment, hot oiling and the use of paraffin inhibitors and dispersants.

### SUMMARY

According to one embodiment, a paraffin inhibitor formulation includes one or more anionic sulfonated surfactants, one or more polymers, and one or more solvents.

### BRIEF DESCRIPTION OF THE DRAWINGS

FIG. 1 depicts a graph illustrating the percent wax removal using experimental polymers A to G in modified cold finger testing.

FIG. 2 depicts a series of photographs illustrating the state of cold fingers at the end of the experiments for experimental polymers A to G at concentrations of 50 ppm, 100 ppm, and 250 ppm during the modified cold finger tests.

FIG. 3 depicts two photographs of paraffin deposits on glass jars at the start of the experiment and at the end of a cold flask test experiment (t=2 hr).

FIG. 4 depicts a series of photographs illustrating the paraffin deposits on glass jars at the end of a cold flask test experiment for experimental polymer A to G (t=2 hr).

FIG. 5 depicts a graph illustrating the percent wax inhibition during a cold finger test and the cost reduction compared to the polymer only case (polymer E) and with varying amounts of surfactant H and polymer E.

FIG. 6 depicts a graph illustrating the percent wax inhibition during a cold finger test and the cost reduction compared to the polymer only case (polymer E) and with varying amounts of surfactant I and polymer E.

FIG. 7 depicts a graph illustrating the percent wax inhibition during the cold finger test and the cost reduction compared to the polymer only case (polymer E) and with varying amounts of surfactant J and polymer E.

### DETAILED DESCRIPTION

### Definitions

As used herein, the term “pour-point” refers to the lowest temperature below which a liquid stops pouring or flowing.

As used herein, the term “surfactant” or “surface-active agents” refers to chemical species that comprise a hydrophobic tail and hydrophilic head which have an affinity to diffuse to the fluid-fluid interface and to lower the interfacial tension.

As used herein, the term “subterranean formation” or “subsurface formation” means a hydrocarbon-containing reservoir that is present below the ground which has a porosity and permeability to store and flow hydrocarbon fluids. The lithology of the reservoir can comprise sedimentary rocks, carbonates such as limestones and dolomites, sandstones, shales, coals, evaporites, igneous, and metamorphic rocks, and combinations thereof. These reservoirs can be fully or partially consolidated or unconsolidated in nature. These formations can be an offshore or onshore reservoir.

As used herein, the term “salt” refers to a chemical compound comprising an ionic assembly of cations and anions. The term includes inorganic salts such as potassium chloride, ammonium chloride, sodium chloride, calcium chloride, magnesium chloride and organic salts such as sodium acetate, sodium citrate and combination thereof.

As used herein, the term “stable” means a formulation that is both thermally stable as well as colloidally stable at the specified temperature. The formulation is free from any coagulation, phase-separation, or precipitation of any component/phase of the mixture.

The present disclosure generally relates to paraffin inhibitor formulations that can inhibit formation of paraffin aggregates and paraffin deposition on metal surfaces during oil and gas production. In certain embodiments, the formulations can be a mixture of one or more surfactants, solvents, and polymers. The polymers can be known paraffin inhibiting additives such as wax crystallization modifiers. The methods and formulations disclosed herein can be useful to prevent issues related to paraffin aggregates and deposition in applications including upstream hydrocarbon production, transportation, storage, and refining.

As can be appreciated, paraffin inhibitors are known to hinder the growth and deposition of paraffin. For example, paraffin inhibitors can alter the wax crystallization behavior. The paraffin inhibitors can also, or alternatively, affect the nucleation process or can co-crystallize with the paraffin crystals affecting and retarding their crystallization behavior. The commonly used wax crystallization modifiers used in the oil and gas industry can include polymer-based chemical additives such as ethylene-vinyl acetate copolymer (EVA), modified ethylene vinyl acetates, alkyl phenol resins, alkyl acrylates, and mixtures thereof.

It has presently been recognized that the performance of paraffin inhibitors can be improved by including the inhibitors in a formulation with one or more surfactants. These formulations can synergistically improve the performance of the paraffin inhibitors in different aspects such as an increment in the percentage paraffin inhibition, a reduction in pour point, improvement in paraffin dispersancy, and reduction in affinity of paraffin to attach to metal surfaces. The surfactants can work synergistically with the polymer additives to improve the technical performance and economic advantage of the polymer additives alone.

Surfactants and wax crystallization modifiers, such as polymer additives, can synergistically assist in the flow assurance process during subsurface applications by performing one or more of the following functions:
a) lowering the pour point of the crude oil.
b) improving the flow characteristics of the crude oil by reducing the viscosity.
c) preventing paraffin deposition on metal surfaces.
d) preventing and/or dispersing paraffin aggregates in the crude oil.

### Surfactants

Suitable surfactants for the presently disclosed paraffin inhibitor formulations can be, or can comprise mixtures of, an anionic sulfonated surfactant represented by Formula I:

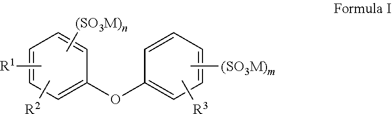

wherein:
R¹—represents a hydrogen, or a linear or branched C₆-C₃₀ alkyl;
R²—represents a hydrogen, or a linear or branched C₆-C₃₀ alkyl;
R³—represents a hydrogen, or a linear or branched C₆-C₃₀ alkyl;
M represents an M is hydrogen, or a cation such as alkali metal, alkaline earth metal, alkanolammonium, aminoalcohol ion, or an ammonium represented by N(R⁴)₄; wherein R⁴ independently represents a hydrogen, or a linear or branched C₃-C₆ alkyl;
m—represents an integer of 1 or 2; and
n—represents an integer of 0 or 1; and
wherein at least one and no more than two of R¹, R², and R³, represents a linear or branched C₆-C₃₀ alkyl.

In certain embodiments, the surfactant can be represented by Formula I where:
a) R¹ represents a linear or branched alkyl group with an average carbon chain length of about 6, 10, 12, or 16.
b) R² and R³ represent a hydrogen

In other embodiments, the surfactant can be a surfactant from the following family: CALFAX-type sulfonated surfactants, DOWFAX-type sulfonated surfactants, ARISTONATE-type sulfonated surfactants, and CALIMULSE-type sulfonated surfactants. DOWFAX-type sulfonated surfactants are available from the Dow Chemical Co. (Midland, Mich.). CALFAX-type, ARISTONATE-type, and CALIMULSE-type sulfonated surfactants are available from the Pilot Chemical Co. (Cincinnati, Ohio).

The composition of CALFAX-type specialized surfactant can include C10 (Linear) Sodium Diphenyl Oxide Disulfonate; C16 (Linear) Sodium Diphenyl Oxide Disulfonate; C6 (Linear) Diphenyl Oxide Disulfonic Acid; C12 (Branched) Sodium Diphenyl Oxide Disulfonate; C12 (Branched) Diphenyl Oxide Disulfonic Acid; Sodium Alkyl Diphenyl Oxide Sulfonate; Sodium Decyl Diphenyl Oxide Disulfonate; Benzenesulfonic Acid, Decyl(sulfophenoxy)-, Disodium Salt; Sodium Hexadecyl Diphenyl Oxide Disulfonate; Benzenesulfonic Acid, Hexadecyl(sulfophenoxy)-, Disodium Salt; Hexyl Diphenyl Oxide Disulfonic Acid; Benzene, 1,1′-oxybis-, Sec-hexyl Derivs., Sulfonated; Sodium Dodecyl Diphenyl Oxide Disulfonate; 1,1′-oxybisbenzene Tetrapropylene Derivs., Sulfonated, Sodium Salt; Benzenesulfonic acid, branched dodecyl(sulfophenoxy), disodium salt; Benzenesulfonic acid, decyl(sulfophenoxy), disodium salt; Dodecyl Diphenyl Oxide Disulfonic Acid; Benzene, 1,1′-oxybis-, Tetrapropylene Derivs., Sulfonated; Disodium oxybis(dodecylbenzenesulfonate); Disodium dodecyl(sulfophenoxy)-benzenesulfonate; Sodium dodecyl(phenoxy)-benzenesulfonate; Sodium oxybis(dodecylbenzene)sulfonate; Benzenesulfonic acid, branched dodecyl-, (branched dodecyl phenoxy), sodium salt; Benzenesulfonic acid, phenoxy, branched dodecyl-, sodium salt; Benzenesulfonic acid, oxybis(branched dodecyl-), disodium salt; Disodium oxybis(dodecylbenzenesulfonate); Disodium dodecyl(sulfophenoxy)-benzenesulfonate; and Sodium dodecyl(phenoxy)-benzenesulfonate Disodium dodecyl(sulfophenoxy)-benzenesulfonate.

Specific surfactants suitable for the present disclosure available in the CALFAX family can include CALFAX 10L-45, CALFAX 16L-35, CALFAX 6LA-70, CALFAX DB-45, CALFAX DBA-40, CALFAX DBA-70, and CALFAX 16LA.

Suitable CALFAX-type surfactants can include non-neutralized, acid versions of the surfactants.

In certain embodiments, the surfactant in the paraffin inhibitors formulations can include DOWFAX-type surfactants. Such surfactants can include a pair of sulfonate groups on a diphenyl oxide backbone. The attached hydrophobe can be a linear or branched alkyl group comprised of six to sixteen carbons.

The composition of DOWFAX-type specialized surfactant can include 1,1′-oxybisbenzene Tetrapropylene Derivs., Sulfonated, Sodium Salt; Benzene, 1,1′-oxybis-, Sec-hexyl Derivs., Sulfonated; Benzene, 1,1′-oxybis-, Tetrapropylene Derivs., Sulfonated; Benzenesulfonic acid, branched dodecyl(sulfophenoxy), disodium salt; Benzenesulfonic acid, branched dodecyl-, (branched dodecyl phenoxy), sodium salt; Benzenesulfonic acid, decyl(sulfophenoxy), disodium salt; Benzenesulfonic Acid, Decyl(sulfophenoxy)-, Disodium Salt; Benzenesulfonic Acid, Hexadecyl(sulfophenoxy)-, Disodium Salt; Benzenesulfonic acid, oxybis(branched dodecyl-), disodium salt; Benzenesulfonic acid, phenoxy, branched dodecyl-, sodium salt; C10 (Linear) Sodium Diphenyl Oxide Disulfonate; C12 (Branched) Diphenyl Oxide Disulfonic Acid; C12 (Branched) Sodium Diphenyl Oxide Disulfonate; C16 (Linear) Sodium Diphenyl Oxide Disulfonate; C6 (Linear) Diphenyl Oxide Disulfonic Acid; Disodium dodecyl(sulfophenoxy)-benzenesulfonate; Disodium dodecyl(sulfophenoxy)-benzenesulfonate; Disodium oxybis(dodecylbenzenesulfonate); Disodium oxybis(dodecylbenzenesulfonate); Dodecyl Diphenyl Oxide Disulfonic Acid; Hexyl Diphenyl Oxide Disulfonic Acid; Sodium Alkyl Diphenyl Oxide Sulfonate; Sodium Decyl Diphenyl Oxide Disulfonate; Sodium Dodecyl Diphenyl Oxide Disulfonate; Sodium dodecyl(phenoxy)-benzenesulfonate; Sodium dodecyl(phenoxy)-benzenesulfonate Disodium dodecyl(sulfophenoxy)-benzenesulfonate; Sodium Hexadecyl Diphenyl Oxide Disulfonate; and Sodium oxybis(dodecylbenzene)sulfonate.

Suitable surfactants available in the DOWFAX family can include DOWFAX 2A1, DOWFAX 3B2, DOWFAX C10L, DOWFAX 8390, DOWFAX C6L, DOWFAX 30599, and DOWFAX 2AO.

Suitable DOWFAX-type surfactants can include non-neutralized, acid versions of the surfactants.

In certain embodiments, the anionic surfactants used in the paraffin inhibitors formulations can be represented by the general Formula II:

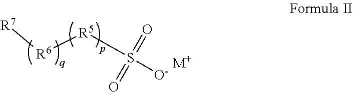

wherein:
R⁵ is a C₅-C₂₀ alkylene chain, a C₆H4 phenylene group, or O;
R⁶ is alkylene oxide units represented by -(EO)ᵣ-(PO)ₛ-, where EO represents oxyethylene, PO represents oxypropylene, r represents an integer of 0 to 30; s represents an integer of 0 to 30;
R⁷ is a hydrogen or linear or branched C₅-C₂₀ alkyl chain;
p represents an integer of 1 or 2;
q represents an integer of 0 or 1;
M represents a hydrogen, or a cation such as alkali metal, alkaline earth metal, alkanolammonium, aminoalcohol ion, or an ammonium represented by N(R⁴)₄;
wherein R⁴ independently represents a hydrogen, or a linear or branched C₃-C₆ alkyl;

In certain embodiments, suitable surfactants can be an alkyl benzene or alkyl aryl sulfonate-type anionic surfactant represented by Formula II, wherein:
R⁵ represents a C₆H4 phenylene group;
R⁷ represents a linear or branched C₅-C₂₀ alkyl chain;
p represents an integer equal to 1; and
q represents an integer equal to 0.

In certain embodiments, suitable surfactants for the paraffin inhibitors formulations can be ARISTONATE-type surfactants. Such surfactants can be anionic sulfonated surfactants in either salt or acid forms.

Suitable ARISTONATE-type specialized surfactants can include Sodium Alkyl Aryl Sulfonate, Alkyl Xylene Sulfonates, Calcium Alkyl Aryl Sulfonate, Aristonate C-5000, Aristonate H, Aristonate L, Aristonate M, Aristonate MME-60, Aristonate S-4000, Aristonate S-4600, Aristonate S-5000, and Aristonate VH-2.

In certain embodiments, suitable surfactants for the paraffin inhibitor formulations can include CALIMULSE-type surfactants. Suitable CALIMULSE-type surfactants can be anionic sulfonated surfactants in either salt or acid forms.

ARISTONATE-type specialized surfactants can include Isopropylamine Branched Alkyl Benzene Sulfonate, Isopropylamine Linear Alkyl Benzene Sulfonate, Sodium Alpha Olefin Sulfonate, Sodium Cl4-16 alpha olefin sulfonate, Sodium Branched Alkyl Benzene Sulfonate, Branched Dodecyl Benzene Sulfonic Acid, Sodium Linear Alkyl Benzene Sulfonate, Sodium Linear Alkyl Benzene Sulfonate, Sodium Lauryl Sulfate, and Sodium Branched Dodecyl Benzene Sulfonate.

In certain embodiments, suitable surfactants can comprise mixtures of two or more surfactants represented by aforementioned Formula I, Formula II, ARISTONATE-type specialized surfactant, and ARISTONATE-type specialized surfactant.

### Polymers

In certain embodiments, the paraffin inhibitor formulation includes mixture of one or more surfactants and one or more polymer additives.

As can be appreciated, polymer-based paraffin inhibitors can act as pour point depressants and/or can act to reduce the viscosity of the paraffinic crude oil to improve their flow characteristics. In the present disclosure, suitable polymer additives can alter the paraffin wax crystallization behavior and can inhibit paraffin aggregation.

In certain embodiments, suitable polymer additives include olefin/maleic esters, olefin/maleic imides, ethylene copolymers such as ethylene-vinyl acetate copolymer (EVA), modified ethylene vinyl acetates, alkyl phenol resins, alkyl acrylates, and mixtures thereof.

In certain embodiments, the polymeric additives can include mixtures of alkylene oxide modified alcohol surfactants and amino dicarboxylic acid diesters.

In certain embodiments, the polymeric additives can be comb-shaped copolymers such as maleic anhydride copolymer. Such copolymers can include non-polar alkyl chain groups and polar groups such as ethyl vinyl, styrene, esters, and carboxylic groups.

In certain embodiments, the polymeric additives can be styrene-maleic acid dialkyl ester polymers formed of building blocks having the following formulas:

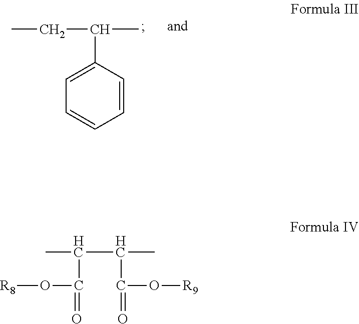

wherein:
R₈ and R₉ are independently selected functional groups and can be the same or different; and
R₈ and R₉ are either a hydrogen of linear or branched C5-C60 alkyl group.

In certain embodiments, a suitable styrene-maleic acid dialkyl ester polymers can be formed of the building blocks of Formulas III and IV in a ratio from about 10:90 to about 90:10.

In certain embodiments, about 90% or more of the polymeric additives can be styrene-maleic acid dialkyl ester polymer.

In certain embodiments, the polymeric additives can be formed of alkylphenol-formaldehyde building blocks of Formula V:

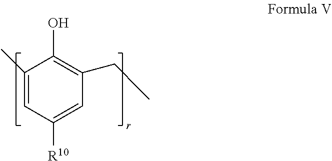

wherein:
R¹⁰ is either linear or branched C5-C60 alkyl group; and
r is an integer of 2-250.

In certain embodiments, about 90% or more of the polymeric additive can comprise the alkylphenol-formaldehyde building blocks of Formula V.

In certain embodiments, the polymeric additives can comprise acrylates polymers formed of building blocks of Formula VI:

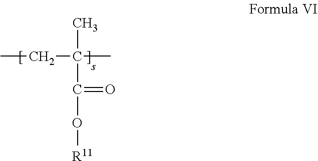

wherein:
R¹¹ is either linear or branched C5-C50 alkyl group; and
s is an integer of 1-200.

In certain embodiments, the polymeric additive can be of combinations of two or more types of acrylates with building blocks of Formula VI, each of the two or more acrylates having different R¹¹.

In certain embodiments, the polymeric additives can comprise copolymers formed of one or more alpha-olefin monomers of general formula VII and maleic anhydride monomers of general formula VIII.

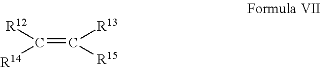

wherein:
R¹², R¹³, R¹⁴, and R¹⁵ are independent of each other and are either hydrogen or linear or branched C5-C50 alkyl group; and

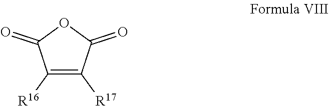

wherein:
R¹⁶ and R¹⁷ are independent of each other and are either hydrogen or linear or branched C1-C50 alkyl group;

In certain embodiments, the polymeric additives can be copolymers formed of alpha-olefin monomers and unsaturated dicarboxylic acid anhydride monomers.

In the present disclosure, different polymeric additives can have synergistic interactions with the aforementioned surfactant compositions. The synergistic interactions can improve the technical performance of the paraffin inhibitor.

### Solvent

The novel paraffin inhibitor formulations described in the present disclosure can include solvent to reduce the viscosity of the final concentrated product and to make it easier to pump. Suitable solvents can include oil-soluble organic liquids which can disperse the surfactant and the polymer. In certain embodiments, the solvent can be selected from benzene, toluene, xylene, ethyl benzene, propyl benzene, trimethyl benzene, cyclopentane, cyclohexane, carbon disulfide, decalin and mixtures thereof.

Paraffin inhibitor formulations described herein can be useful for paraffin inhibiting and/or remediation during different upstream applications such hydraulic fracturing, production in conventional and unconventional reservoirs, midstream applications such as pipelines flows and downstream application such as refinery.

In certain embodiments, the paraffin inhibitor formulations described herein can include about 5% to about 95%, by weight solvent, about 1% to about 95%, by weight, surfactants, and about 1% to about 95%, by weight, of wax crystallization modifiers such as polymers additives. As can be appreciated, small amounts of additional components such as viscosity modifiers, stabilizers, and biocides can be included in certain embodiments.

In certain embodiments, paraffin inhibitor formulations can be formed by combining the polymer (wax crystallization modifier) and surfactants together and then diluting with a solvent until the formulation reaches a desired viscosity. Generally, each of the components can be admixed together as known in the art using, for example, mixing equipment.

As can be appreciated, certain paraffin inhibitor formulations can be formed to allow for easier transport and additional flexibility by incorporation of less or even no solvent. Prior to use, such paraffin inhibitor formulations can incorporate additional solvent to become a diluted paraffin inhibitor formulation. The additional solvent can be the same solvent used to the form the paraffin inhibitor formulation or a different solvent such as one or more of benzene, toluene, xylene, ethyl benzene, propyl benzene, trimethyl benzene, cyclopentane, cyclohexane, carbon disulfide, decalin and mixtures thereof. The concentration of additional solvent used to dilute the diluted paraffin inhibitor formulation can vary from about 0% to about 95% by weight.

The paraffin inhibitor formulations in both diluted and non-diluted forms can remain stable before injection in the wellbore, within the wellbore, as well as when it interacts and mixes with the formation fluids at reservoir temperatures. The paraffin inhibitor formulation can remain stable irrespective of the salinity or salt content of the formation water. Hydrocarbon producing subterranean formation can be treated to mitigate paraffin related issues by admixing the paraffin inhibitor formulation described herein with the formation fluid. In such methods, the paraffin inhibitor formulation could be admixed with a formation fluid within a wellbore or flowline. Alternatively, the paraffin inhibitor formulation can also be admixed with a formation fluid by injecting the paraffin inhibitor formulation into production equipment handling hydrocarbons from the subsurface reservoir.

The paraffin inhibitor formulation can be injected into the formation through an injection well. The reservoir temperature of the subterranean formation where such treatment can be applied can be greater than 68° F. (20° C.). The concentration of paraffin inhibitor used in such application can be between 5 ppm to 20,000 ppm (weight:weight)

### Methods of Use

### Methods and Materials

### Oil & Wax Characterization

The Wax Appearance Temperature (“WAT”) of the paraffin waxes was determined using cross-polarization microscopy. Carbon chain analysis of the wax was performed using High-Temperature Gas Chromatography (“HTGC”). The physical properties of the crude oil samples evaluated are depicted in Table 1. The crude oil samples were sourced from the Permian Basin.

TABLE 1

| Crude | | | | | | % Filterable |
|---|---|---|---|---|---|---|
| Oil | API Gravity | Cloud Point | Pour Point | % Paraffins | % Asphaltenes | Solids |
| 1 | 39 | 28° C. | <−32 C° C. | 2.84% | 0.15% | 0.06% |
| 2 | 41 | 13° C. | <−32° C. | 3.61% | 0.10% | 0.01% |

### Cold Finger Test

The procedure utilized in the cold finger test is as follows:
1. Crude oil containing paraffin wax was transferred into a jacketed glass vessel and preheated to 55° C. (above the wax appearance temperature or WAT) using a bath thermostat and mixed continuously at 1000 rpm using a magnetic stirrer to homogenize the oil-wax system and avoid any effect of thermal history on the wax crystallization behavior.
2. The finger temperature was maintained by another thermostat operating at 19.7° C.
3. The mixing rate was set to 200 rpm and the finger was submerged in the crude oil for 5 hours.
4. The total amount of wax deposited on the cold finger was determined by scraping the finger and accurately weighing the deposit.
5. This experiment was performed with and without the addition of paraffin inhibitor additive and the percent change in the mass of the deposit was calculated which is referred to as the percent wax inhibition obtained by use of the paraffin inhibitor.

### Modified Cold Finger Test

The procedure utilized in the modified cold finger testing is as follows:
1. Oil is preheated and held at 82° C. for at least 4 hours prior to use to avoid any effect of thermal history on the wax crystallization behavior.
2. The preheated oil is inverted or stirred to ensure a homogeneous oil solution.
3. 80 mL of oil is measured for each evaluation.
4. The measured quantity of oil is placed in a hot block and allowed to reach run temperature. A magnetic stir rate is set at 100 rpm.
5. Cold Finger sleeves are weighed.
6. The Cold Finger sleeves are lowered into the samples of measured oil.
7. Samples run for a 16-hour Deposition Step or other desired time
8. At the end of the run the Cold Finger sleeves are removed from the oil and allowed to drip.
9. Additional free oil is rinsed from the Cold Finger sleeves by immersion in Methyl Ethyl Ketone.
10. The Cold Finger sleeve is allowed to dry for 10 minutes.
11. The Post Deposition Weight of the Cold Finger sleeve is recorded.
12. The measured oil samples are dosed with the example compositions (e.g., the paraffin inhibitor formulations) at various rates.
13. The Cold Finger sleeves are cleaned and reinstalled.
14. The Cold Finger sleeves are lowered into the dosed example compositions.
15. The Cold Finger sleeves are immersed in the dosed example compositions for a 4-hour Dispersant Step or other desired time.
16. At the end of the run the Cold Fingers sleeves are removed from the oil and allowed to drip.
17. Additional free oil is rinsed by immersion of the Cold Finger sleeves in Methyl Ethyl Ketone.
18. The Cold Finger sleeve is allowed to dry for 10 minutes.
19. The Post Dispersant Weight of Cold Finger sleeve is recorded.

### Paraffin Dispersant Test—Cold Flask Method

The procedure utilized in the cold flask paraffin dispersant testing is as follows:
1. Test containers are weighed.
2. Approx. 2-3 g of paraffin is added to each test container.
3. 50 mL of fluid (90% water and 10% crude oil) is added to each test container.
4. Samples are dosed with the specified amount of product, leaving one untreated as a blank (base reference case).
5. Samples are placed on a shaker table and are shaken on low speed for 1-hour intervals.
6. At the completion of the test, samples are observed for paraffin adherence to the container, dispersion in the fluid, and remaining large pieces of paraffin that are neither adhered to a surface or dispersed.

### EXAMPLES

The following examples are reported to illustrate the efficacy of the paraffin inhibitor formulations described herein.

The properties of the crude oil and wax samples are depicted in Table 1. A commercial multi-place cold finger setup was used according to the test procedures described herein.

A comprehensive polymer screening was performed to determine the best polymer additive for the paraffin inhibitor formulation. The chemistries of the experimental polymers in the current evaluations are depicted in Table 2.

TABLE 2

| Polymer # | Chemistry |
|---|---|
| A | C24-28 alpha olefin copolymer-long |
| B | C24-28 alpha olefin copolymer-short |
| C | C24-28 alpha olefin copolymer |
| D | Amine sulfonate mixture |
| E | Copolymer Ester |
| F | Polyalkylated Phenol |
| G | Copolymer Ester |

Oil samples containing fixed amount of paraffins were preheated at 82° C. (above the wax appearance temperature, WAT) and mixed thoroughly to ensure a homogenous solution with no thermal history for the wax crystallization behavior. 80 mL of this oil was transferred to a sample container maintained at a temperature of 41.9° C. using a thermostat bath and a magnetic stir rate of 100 rpm. Cold finger sleeves which mimic wellbore tubing were maintained at a lower fixed temperature of 19.7° C. The cold finger sleeves were lowered into the 80 mL oil solution and paraffin was allowed to deposit on the cold finger sleeve for 16 hours. The amounts of paraffin deposited were recorded as the base case (e.g., without the paraffin inhibitor formulations). In the subsequent test, paraffin inhibitor formulations with different polymer chemistries were evaluated by adding the formulations to the 80 mL oil samples at concentrations of 50 ppm, 100 ppm, and 250 ppm. The amount of paraffin deposition was measured gravimetrically and the percent wax removal was calculated by comparing to the base case deposition.

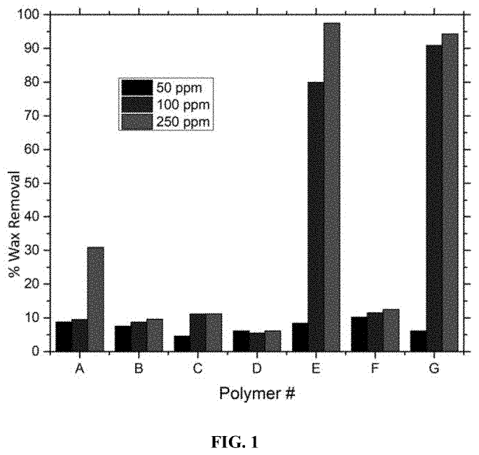

FIG. 1 illustrates the results for polymers A to G for each of the three concentrations. Based on these results, polymers E and G were screened. Polymer E exhibited 79.9% and 97.5% wax removal for 100 ppm and 250 ppm dosing respectively. Polymer G exhibited 90.9% and 94.3% wax removal for 100 ppm and 250 ppm dosing respectively.

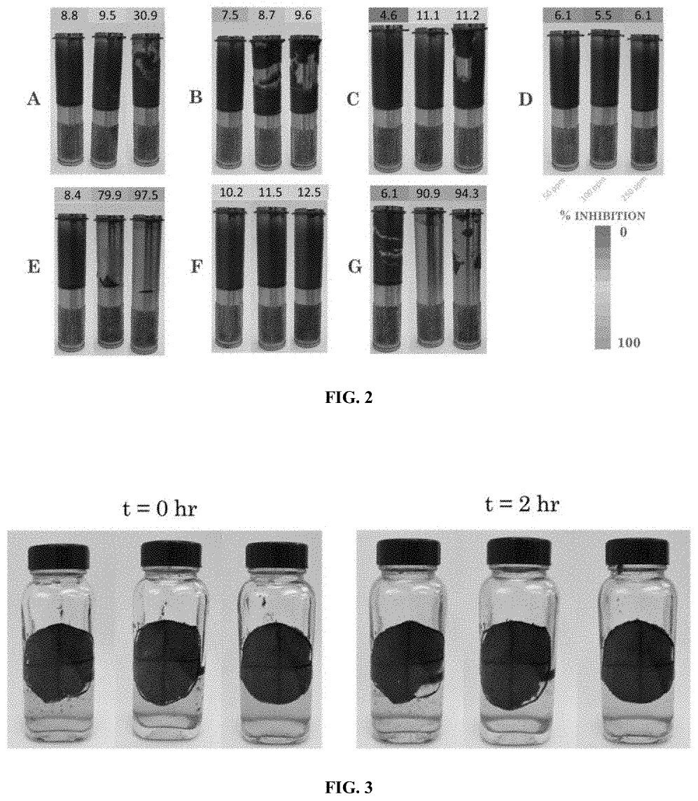

FIG. 2 illustrates the final state of the cold fingers at the end of the experiment for each of the seven polymers systems when dosed at concentrations of 50 ppm, 100 ppm, and 250 ppm from left to right. As illustrated in FIG. 2, it can be seen that polymers E and G, at both 100 ppm and 250 ppm dosing, resulted in clean fingers with more than 90% wax removal indicating their respective efficacies in removing the deposited wax and inhibiting wax deposition.

The efficacy of the different polymers was further evaluated using the cold flask method. In the cold flask evaluation, about 2 gm of wax was placed on the glass wall of the square-shaped jar. A 50-ml solution (90% water and 10% crude oil) with no polymer additive was poured in the jar and mixed for 2 hours on a shaker table.

FIG. 3 depicts a photograph showing the state of the deposited wax at t=0 hr and t=2 hrs. No significant change in the wax deposition area was observed. This case was treated as the blank case.

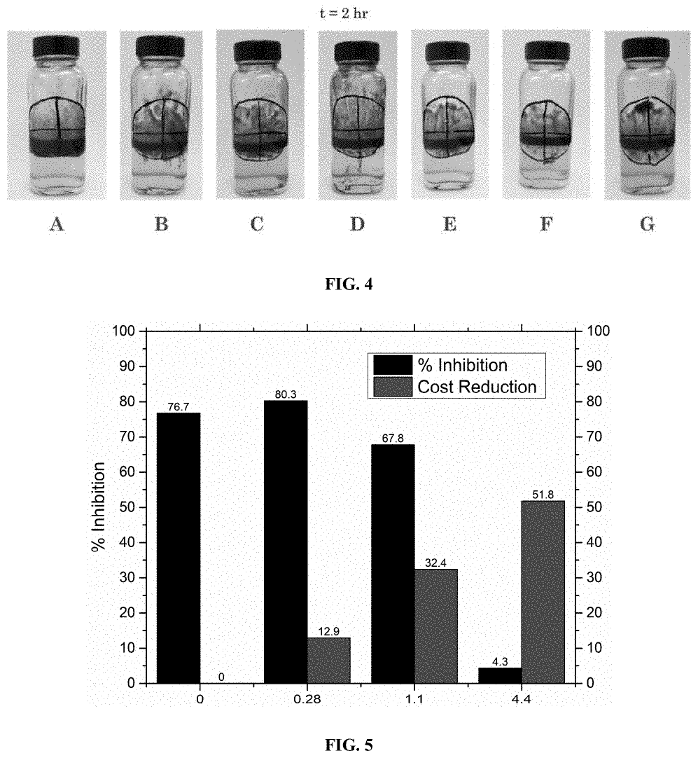

In the next evaluation, polymers A to G were evaluated in similar jars with wax deposited on the wall. The jars were mixed for 2 hours with polymer dosing of 250 ppm and were monitored for changes in the wax deposition. FIG. 4 shows the final state of the wax for each of the polymers after 2 hours. All the polymers A to G were able to disperse the solid wax deposited on the glass exhibiting their potential of dispersing solid paraffin.

In the subsequent working evaluations, the effect of varying the ratio of surfactant to polymer was evaluated on total paraffin inhibition using a cold finger test. The total reduction in chemical cost as compared to the use of only polymer was also determined. As can be appreciated, polymers are typically more expensive than surfactants. The use of synergistic surfactants as described in the present disclosure can allow for identical or improved paraffin inhibition performance with reduced cost compared to the use of a polymer alone. This reduction in overall cost of the paraffin inhibitor formulation can make it attractive for oilfield applications.

The effect of different ratios of Surfactant H to Polymer E (copolymer ester) on paraffin inhibition was evaluated using cold finger tests. The results of this evaluation are depicted in FIG. 5. The surfactant H is an alkyl benzene or alkyl aryl sulfonate-type anionic surfactant represented by Formula II:

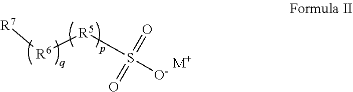

wherein:
i. R⁵ represents a C₆H₄ phenylene group;
ii. R⁷ represents a linear or branched C₅-C₂₀ alkyl chain;
iii. p represents an integer equal to 1; and
iv. q represents an integer equal to 0.

As depicted in FIG. 5, when the ratio of surfactant to polymer is 0.28, the percent inhibition is increased from 76.7% to 80.3% while the chemical cost is reduced by 12.9%. For the higher ratios of 1.1 and 4.4, the technical performance was 67.8% and 4.3%, respectively with a cost reduction of 32.4% and 51.8%, respectively. Therefore, for this surfactant-polymer combination, the ratio of 0.28 was found to be optimal as it gives both the maximum performance at an effective chemical cost.

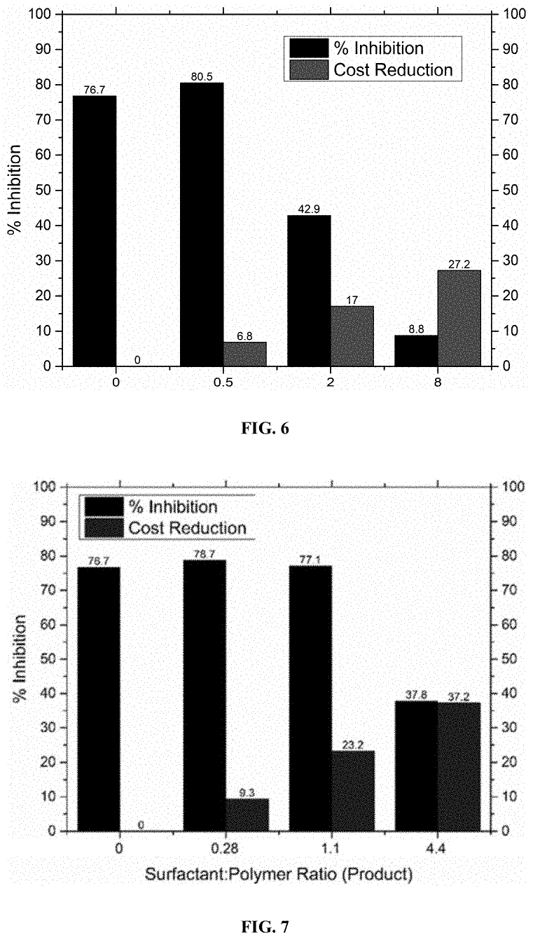

In the next evaluation, the effect of differing ratios of Surfactant I to Polymer E (copolymer ester) on percentage paraffin inhibition was evaluated using cold finger tests. Surfactant I is an ARISTONATE-type surfactant. This surfactant is an anionic, oil-soluble sulfonated surfactant in acid form. The results of this evaluation are depicted in FIG. 6. .

FIG. 6 depicts the plot of percentage paraffin inhibition for the differing ratios of Surfactant I and Polymer E. For a ratio of surfactant to polymer of 0.5, the % inhibition increased from 76.7% to 80.5% with a 6.8% reduction in total chemical cost. For the ratio of the 2 and 8, the total inhibition was 42.9% and 8.8%, respectively. The optimal ratio of surfactant to polymer in this formulation of 0.5 based on both performance and cost.

In the next evaluation, the effect of differing ratios of Surfactant J to Polymer E (copolymer ester) on percentage paraffin inhibition was evaluated using cold finger tests. Xylene was used as a solvent to mix the polymer and surfactant and was present at a concentration of 20% by weight. Surfactant J is a mixture of two surfactants. The ratio of these two surfactants in the Surfactant J blend was 1:1 by weight. One of the surfactants was in its acid-form (non-neutralized) represented by Formula I:

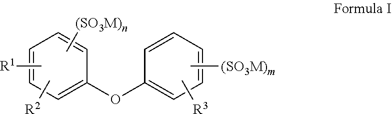

wherein:
a) R¹ represents a linear or branched alkyl group with an average carbon chain length of about 16.
b) R² and R³ represent a hydrogen.

The second surfactant was represented by Formula II:

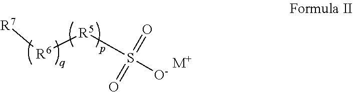

wherein:
1. R⁵ represents a C₆H₄ phenylene group;
ii. R⁷ represents a branched C₅-C₂₀ alkyl chain;
iii. p represents an integer equal to 1; and
iv. q represents an integer equal to 0.

The ratio of polymer to surfactant in the final paraffin inhibitor formulation was 2:1 by weight. FIG. 7 depicts the results of this evaluation.

As depicted in FIG. 7, when the ratio of surfactant to polymer is 1.1, the percent inhibition was 77.1% (similar to polymer only case) but with a 23.2% reduction in total chemical cost. For the ratio of the 0.28 and 4.4, the total inhibition was 78.7% and 37.8%, respectively. The optimal ratio of surfactant to polymer in this formulation is 1.1 based on performance and cost.

Based on the above examples, it is clear that for any crude oil-paraffin system, an optimal surfactant to polymer ratio can be determined which will yield high percent inhibition and reduce the overall chemical cost.

The dimensions and values disclosed herein are not to be understood as being strictly limited to the exact numerical values recited. Instead, unless otherwise specified, each such dimension is intended to mean both the recited value and a functionally equivalent range surrounding that value.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Every document cited herein, including any cross-referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests, or discloses any such invention. Further, to the extent that any meaning or definition of a term in this document conflicts with any meaning or definition of the same term in a document incorporated by reference, the meaning or definition assigned to that term in the document shall govern.

The foregoing description of embodiments and examples has been presented for purposes of description. It is not intended to be exhaustive or limiting to the forms described. Numerous modifications are possible in light of the above teachings. Some of those modifications have been discussed and others will be understood by those skilled in the art. The embodiments were chosen and described for illustration of various embodiments. Certain embodiments disclosed herein can be combined with other embodiments as would be understood by one skilled in the art. The scope is, of course, not limited to the examples or embodiments set forth herein but can be employed in any number of applications and equivalent articles by those of ordinary skill in the art. Rather it is hereby intended the scope be defined by the claims appended hereto.

What is claimed is:

1. A paraffin inhibitor formulation comprising:
i. one or more anionic sulfonated surfactants;
ii. one or more polymers; and
iii. one or more solvents.

2. The paraffin inhibitor formulation of claim 1, wherein the one or more anionic sulfonated surfactants comprise an anionic sulfonated surfactant represented by Formula I: 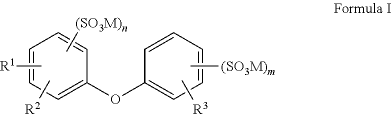
wherein:
R¹—represents a hydrogen, or a linear or branched C₆-C₃₀ alkyl;
R²—represents a hydrogen, or a linear or branched C₆-C₃₀ alkyl;
R³—represents a hydrogen, or a linear or branched C₆-C₃₀ alkyl;
M represents a hydrogen, or a cation comprising an alkali metal, alkaline earth metal, alkanolammonium, aminoalcohol ion, or an ammonium represented by N(R⁴)₄; wherein R⁴ independently represents a hydrogen, or a linear or branched C₃-C₆ alkyl
m—represents an integer of 1 or 2; and
n—represents an integer of 0 or 1; and
wherein at least one and no more than two of R¹, R², and R³, represents a linear or branched C₆-C₃₀ alkyl.

3. The paraffin inhibitor formulation of claim 2 wherein m and n are each equal to 1.

4. The paraffin inhibitor formulation of claim 2 wherein:
a) R¹ represents a linear or branched alkyl group with an average carbon chain length of about 6, 10, 12, or 16; and
b) R² and R³ represent a hydrogen.

5. The paraffin inhibitor formulation of claim 1, wherein the one or more anionic sulfonated surfactants comprise an anionic sulfonated surfactant represented by Formula II: 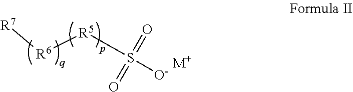
wherein:
R⁵ is a C₅-C₂₀ alkylene chain, a C₆H₄ phenylene group, or O;
R⁶ is alkylene oxide units represented by -(EO)ᵣ-(PO)ₛ-, where EO represents oxyethylene, PO represents oxypropylene, r represents an integer of 0 to 30; s represents an integer of 0 to 30;
R⁷ is a hydrogen or a linear or branched C₅-C₂₀ alkyl chain;
p represents an integer of 1 or 2;
q represents an integer of 0 or 1;
M represents a hydrogen, or a cation comprising an alkali metal, alkaline earth metal, alkanolammonium, aminoalcohol ion, or an ammonium represented by N(R⁴)₄; wherein R⁴ independently represents a hydrogen, or a linear or branched C₃-C₆ alkyl.

6. The paraffin inhibitor formulation of claim 1, wherein the one or more anionic sulfonated surfactants comprise C10 (Linear) Sodium Diphenyl Oxide Disulfonate, C16 (Linear) Sodium Diphenyl Oxide Disulfonate, C6 (Linear) Diphenyl Oxide Disulfonic Acid, C12 (Branched) Sodium Diphenyl Oxide Disulfonate, C12 (Branched) Diphenyl Oxide Disulfonic Acid, or C12 (Branched) Diphenyl Oxide Disulfonic Acid.

7. The paraffin inhibitor formulation of claim 1, wherein the one or more polymers comprise olefin/maleic esters, olefin/maleic imides, or ethylene copolymers, wherein the ethylene copolymers comprise ethylene-vinyl acetate copolymer (EVA), modified ethylene vinyl acetates, alkyl phenol resins, or alkyl acrylates.

8. The paraffin inhibitor formulation of claim 1, wherein the one or more polymers comprise mixtures of alkylene oxide modified alcohol surfactants and amino dicarboxylic acid diesters.

9. The paraffin inhibitor formulation of claim 1, wherein the one or more polymers comprise comb-shaped copolymers comprising maleic anhydride copolymer, wherein the maleic anhydride copolymer comprises non-polar alkyl chain groups and polar groups comprising ethyl vinyl, styrene, esters, or carboxylic groups.

10. The paraffin inhibitor formulation of claim 1, wherein the one or more polymers comprise styrene-maleic acid dialkyl ester polymers.

11. The paraffin inhibitor formulation of claim 10 wherein the styrene-maleic acid dialkyl ester polymer is formed from Formulas III and IV: 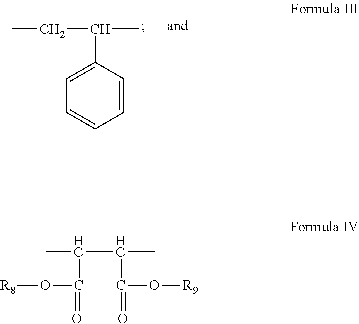
wherein:
R₈ and R₉ are independent functional group from each other; and
R₈ and R₉ are either a hydrogen of linear or branched C5-C60 alkyl group;

12. The paraffin inhibitor formulation of claim 10, wherein about 90% of the one or more polymers comprise the styrene-maleic acid dialkyl ester polymer.

13. The paraffin inhibitor formulation of claim 1, wherein the one or more polymers comprise alkylphenol-formaldehyde: 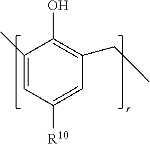
wherein:
R¹⁰ is either linear or branched C5-C60 alkyl group; and
r is an integer of 2-250.

14. The paraffin inhibitor formulation of claim 13, wherein 90% of the one or more polymers comprise the alkylphenol-formaldehyde.

15. The paraffin inhibitor formulation of claim 1, wherein the one or more polymers comprise acrylates polymers formed from Formula VI: 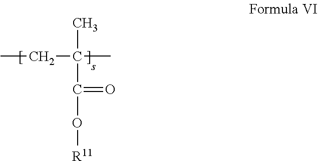
wherein:
R¹¹ is either linear or branched C5-C50 alkyl group; and
s is an integer of 1-200.

16. The paraffin inhibitor formulation of claim 15, wherein the one more polymers comprise two or more acrylates, each of the two or more acrylates formed from Formula VI and having different R¹¹ groups.

17. The paraffin inhibitor formulation of claim 1, wherein the one or more polymers comprise copolymers of one or more alpha-olefin monomers of general formula VII and maleic anhydride monomers of general formula VIII: 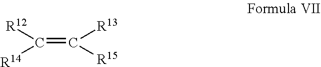
wherein:
R¹², R¹³, R¹⁴, and R¹⁵ are independent of each other and are either hydrogen or a linear or branched C5-C50 alkyl group; and 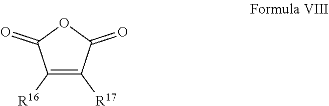
wherein:
R¹⁶ and R¹⁷ are independent of each other and are either hydrogen or a linear or branched C1-C50 alkyl group.

18. The paraffin inhibitor formulation of claim 1, wherein the one or more polymers comprise copolymers of alpha-olefin monomers and unsaturated dicarboxylic acid anhydride monomers.

19. The paraffin inhibitor formulation of claim 1, wherein the one or more solvents comprise benzene, toluene, xylene, ethyl benzene, propyl benzene, trimethyl benzene, cyclopentane, cyclohexane, carbon disulfide, decalin, and mixtures thereof.

20. The paraffin inhibitor formulation of claim 1 comprises about 5% to about 95%, by weight, of the one or more solvents, about 1% to about 95%, by weight, of the one or more surfactants, and about 1% to about 95%, by weight, of the one or more polymers.
